(19) United States
(12) Patent Application Publication
(10) Pub. No.: US 2023/0072322 A1
(43) Pub. Date: Mar. 9, 2023

(54) DYNAMIC USER INTERFACE ANIMATIONS IN A FITNESS APPLICATION

(71) Applicant: ECHELON FITNESS MULTIMEDIA LLC, Chattanooga, TN (US)

(72) Inventors: Lou LENTINE, Stuart, FL (US); John SANTO, Orlando, FL (US)

(21) Appl. No.: 17/467,545

(22) Filed: Sep. 7, 2021

(51) Int. Cl. G06F 3/0485; G06F 3/0488; G06F 40/109; G06F 3/0482

(52) U.S. Cl. CPC G06F 3/0485; G06F 3/0488; G06F 40/109; G06F 3/0482

(57) ABSTRACT

The present application is directed to improvements in user interfaces. In an embodiment, a method is disclosed comprising displaying a main tile in a user interface (UI); detecting a user interaction with the UI; moving the main tile and a secondary tile, the secondary tile adjacent to the main tile; and adjusting a property of the secondary tile while moving the secondary tile, the property adjusted based in part on a position of the secondary tile during the moving

### BACKGROUND

Since the advent of third-party mobile applications, such applications have become more and more data-driven, driven in part by the ease of high-speed network access. As the amount of displayable content increases and the screen size of mobile devices remains relatively small, there are significant technical challenges in manipulating, arranging, and presenting content in a digestible manner.

### BRIEF SUMMARY

The example embodiments describe user interfaces and, in particular, mobile user interfaces. In some of the example embodiments, a mobile application organizes data into tiles which it then displays in a full state, hidden state, and in a continuous sequence of intermediate states between the full and hidden states. During this continuous sequence, the example embodiments modify the data of the tile based on the position of the tile with respect to the mobile device and other user interface (UI) elements.

In the example embodiments, methods, computer-readable media, and devices are disclosed for displaying a main tile in a user interface; detecting a user interaction with the UI; moving the main tile and a secondary tile, the secondary tile adjacent to the main tile; and adjusting a property of the secondary tile while moving the secondary tile, the property adjusted based in part on a position of the secondary tile during the moving

In an embodiment, the embodiments display the secondary tile prior to moving the main tile and the secondary tile, wherein displaying the secondary tile comprises displaying a portion of the secondary tile while the secondary tile.

In an embodiment, moving the main tile and the secondary tile comprises scrolling the main tile and the secondary tile along a horizontal axis of the UI. In an embodiment, detecting the user interaction comprises detecting a swipe gesture. In an embodiment, adjusting the property of the secondary tile comprises increasing a text size of an item of the secondary tile proportionate to a change in position caused by the moving. In an embodiment, adjusting the property of the secondary tile comprises adjusting a position of an item of the secondary tile proportionate to a change in position caused by the moving. In an embodiment, the property of the secondary tile comprises adjusting the transparency of an item of the secondary tile proportionate to a change in position caused by the moving. In an embodiment, adjusting the property of the secondary tile comprises displaying a control. In an embodiment, adjusting the property of the secondary tile comprises increasing a text size of an item of the secondary tile proportionate to a change in position caused by the moving; adjusting a position of the item of the secondary tile proportionate to the change in position caused by the moving; adjusting the transparency of the item of the secondary tile proportionate to the change in position caused by the moving; and displaying a control.

### BRIEF DESCRIPTION OF THE DRAWINGS

FIG. 1 is a flow diagram illustrating a method for managing a UI according to some embodiments.

FIG. 2 is a flow diagram illustrating a method for adjusting a UI tile according to some embodiments.

FIG. 3 is a flow diagram illustrating a method for adjusting the display properties of a UI tile according to some embodiments.

FIG. 4 is a flow diagram illustrating a method for updating a UI display according to some embodiments of the disclosure.

FIG. 5 is a user interface diagram of a portrait-oriented UI according to some embodiments.

FIG. 6A is a user interface diagram of a UI tile in a first state according to some embodiments.

FIG. 6B is a user interface diagram of a UI tile in a second state according to some embodiments.

FIG. 6C is a user interface diagram of a UI tile in a third state according to some embodiments.

FIG. 7 is a user interface diagram of a landscape-oriented UI according to some embodiments.

FIG. 8 is a block diagram of a computing device according to some embodiments.

### DETAILED DESCRIPTION

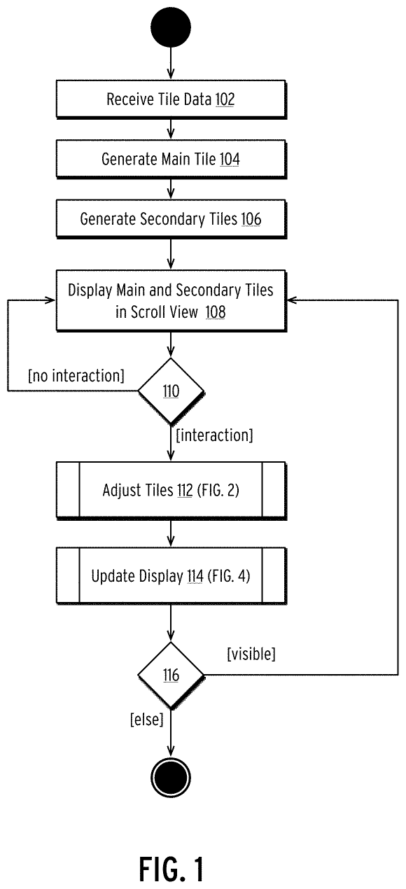

FIG. 1 is a flow diagram illustrating a method for managing a UI according to some embodiments.

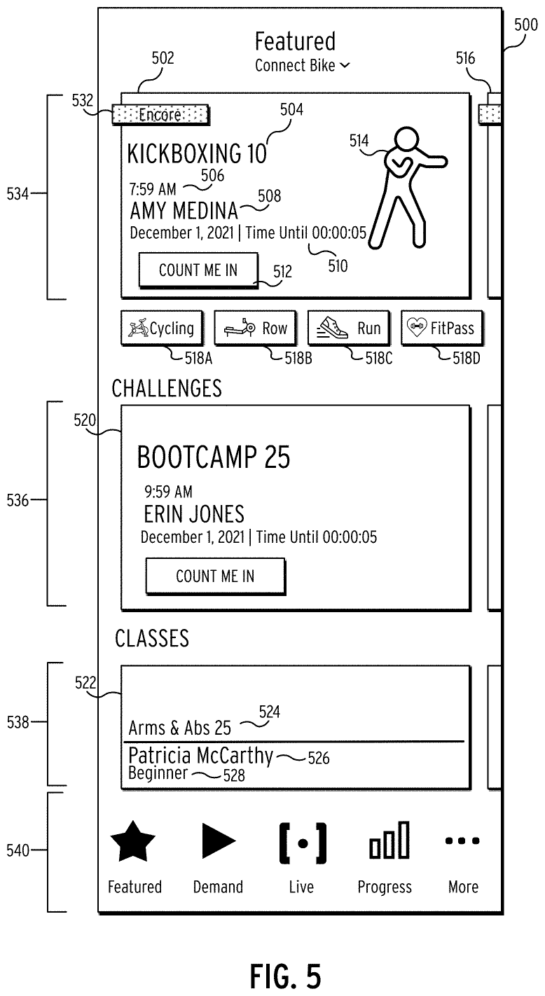

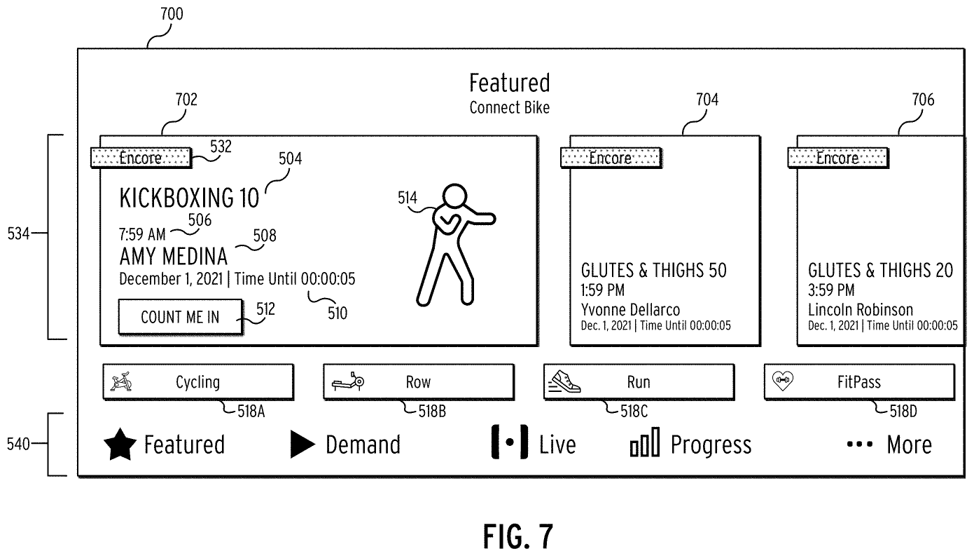

In step 102, the method can comprise receiving tile data. In some embodiments, tile data refers to text, image, audio, video, or other content capable that a mobile device can present to the user via a display, speaker, or another output device. As one example, illustrated in FIGS. 5 and 7, tile data can comprise text content such as headings, subheadings, and body text, as well as image content. Further, in some embodiments, the tile data can comprise controls such as buttons, touch targets, and other controls. In some embodiments, these controls can comprise programmatic controls that perform actions in response to user input. In other embodiments, the tile data can comprise metadata that the mobile application can use to construct a UI element. For example, the tile data can include a deep link that the mobile application can use to construct a control (e.g., button) rendered in the tile.

In some embodiments, the tile data can comprise a set of properties for multiple tiles. In such an embodiment, the tile data can comprise an array of tile data objects. In some embodiments, the array can be ordered such that a main tile appears in the first index of the array. In other embodiments, the array can be unordered, and each tile can include a flag to indicate whether it is a main tile or not.

In step 104, the method can comprise generating a main tile.

In one embodiment, the method can generate a tile (including a main tile) using a tile template. In one embodiment, a tile template can comprise a defined structure for rendering a tile. The method can load a tile template and populate the tile template with some, or all, of the tile data received in step 102. For example, a tile template can comprise a React Component or similar component that comprises a function accepting tile data as inputs and outputs an object capable of being rendered by a mobile application.

In some embodiments, the method can load tile properties associated with a main tile from the tile data received in step 102. In one embodiment, the tile data received in step 102 can comprise tile properties for a single main tile. In such an embodiment, the method can use the received tile data as the tile properties. In other embodiments, when properties of multiple tiles are received, the method can select the tile properties of a main object (e.g., based on the ordering of the tiles in an array or based on a flag, as described above) in the array.

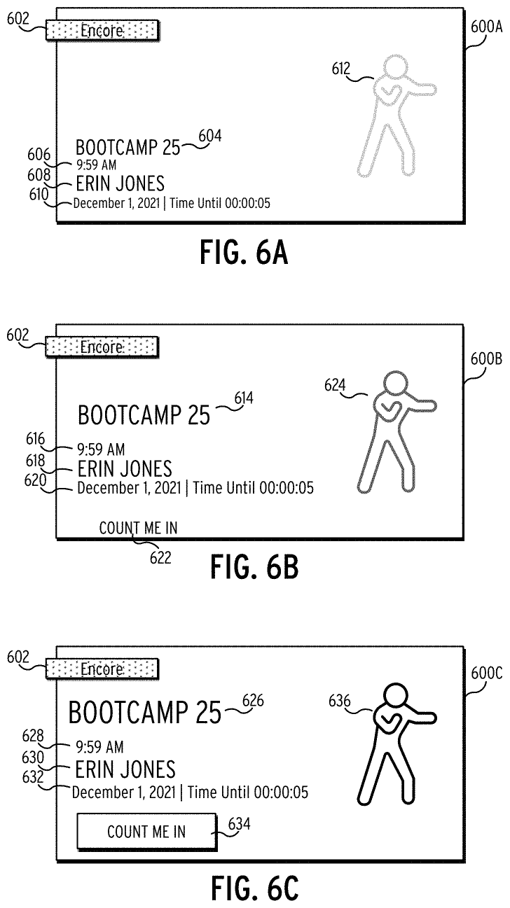

In an embodiment, the main tile can comprise a tile that is completely visible and presented in a full display state (as in FIG. 6C). By contrast, the mobile application can display one or more additional tiles (referred to as secondary tiles) either completely or partially, as will be discussed.

In step 106, the method can comprise generating one or more secondary tiles. In some embodiments, step 106 can be optional. If implemented, the method can perform the operations of step 104 (e.g., populating a tile template) for one or more secondary tiles. In some embodiments, the method can perform step 106 for all tiles included in the tile data. In such an embodiment, the method can effectively preemptively generate the secondary tiles even if the secondary tiles are not immediately displayed.

In step 108, the method can comprise displaying the main and secondary tiles in a scroll view.

In one embodiment, the scroll view can comprise a carousel or similar UI element that enables the movement of UI elements (e.g., tiles) across a screen. In some embodiments, the scroll view can allow for elements to move horizontally (i.e., left-to-right or right-to-left) in response to user input (e.g., swipe gestures, mouse events, keypresses, etc.). In one embodiment, a scroll view can include a plurality of items. In one embodiment, the mobile applications can provide an array of items to the scroll view for display.

In one embodiment, one position of the scroll view can be designated as the main position. In one embodiment, the main tile is placed in this main position. Then, the secondary tiles can be placed in a plurality of other positions in the scroll view. In one embodiment, the main position comprises a position wherein the associate item (e.g., main tile) is displayed in a full display state

In step 110, the method can comprise determining if a user interaction has occurred. If not, the method can repeat steps 108 and 110 until detecting user interaction. If the method detects a user interaction, the method can proceed to step 112. In some embodiments, the user interaction can comprise a swipe gesture, keypress, mouse event, or similar operation.

In one embodiment, the scroll view can receive user input and emit events in response. In one embodiment, the events can include details regarding the underlying user input such as a swipe direction, swipe amount, swipe duration, or similar properties. In one embodiment, the mobile application can include a delegate or other object to receive these events and perform step 112 and subsequent steps in response. In some embodiments, the scroll view can provide programmatic access to underlying items, or the underlying items can be passed by reference to the scroll view. In such an embodiment, the scroll view can delegate modification or updates to tiles to external code, allowing for reuse of the scroll view in other pages of the mobile application (or other mobile applications).

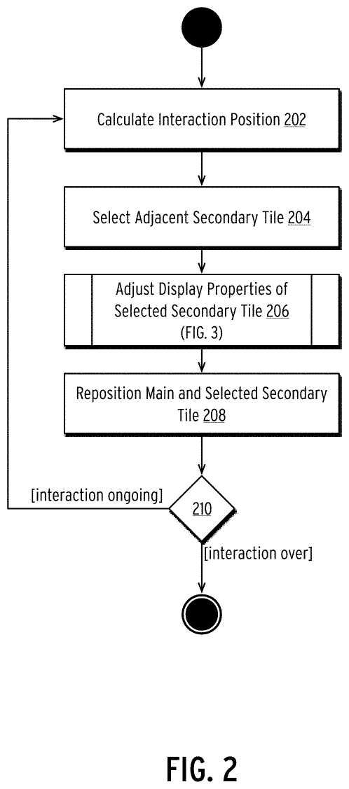

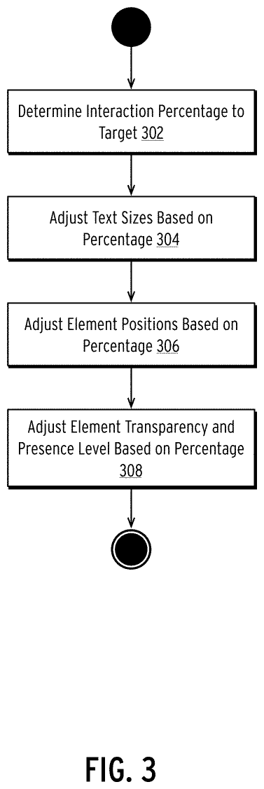

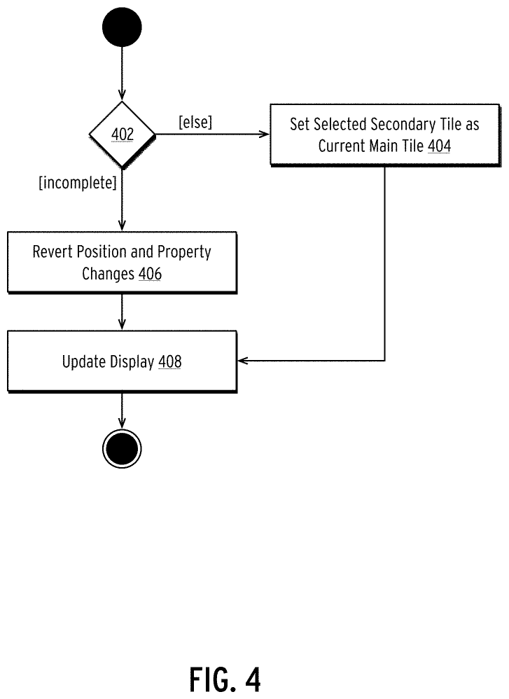

In step 112, the method can comprise adjusting both the main and secondary tiles. FIGS. 2 and 3 provide further detail on the operations of step 112, and that disclosure is incorporated herein in its entirety. In step 114, the method can comprise updating a display of the UI. FIG. 4 provides further detail on the operations of step 114, and that disclosure is incorporated herein in its entirety.

In brief, the method compares analyzes the interaction (e.g., swipe) position to determine the movement of tiles responsive to the interaction. Based on this interaction position, the method can calculate a change in position for the scroll view, including the items therein (e.g., a distance on the horizontal axis to move all items responsive to the interaction). In some embodiments, the change in position can comprise a distance in which a secondary tile should be moved towards or away from the position of a current main tile. In response to this change in position, the method can alter the properties of each tile proportionate to a change in position caused by the interaction.

For example, as a secondary tile moves closer (e.g., the distance between the secondary and location of a main tile is smaller), a text size, transparency, or field position can be modified. As an example, if the center of the main tile slot is at an x-coordinate of zero (0), and the secondary tile is positioned at an x-coordinate of 100, and the interaction moves the secondary tile to an x-coordinate of 50 (and, correspondingly, the main tile in the main tile slot to an x-coordinate of −50), the method can compute a change in position of 50% for the secondary tile. Further, if the text size is defined on a scale of 0 pt to 10 pt and the transparency on a scale of 0 to 100%, the method can adjust these properties to 5 pt and 50%, respectively. Similar operations can be performed with respect to positioning and control insertion, as will be described.

In step 116, the method can comprise determining if the main or secondary tiles are still visible. If so, the method can continue operation starting at step 108. If not, the method can end. In some embodiments, the loop beginning in step 108 can be performed so long as the scroll view or carousel is visible and capable of being interacted with. Further, the loop starting with step 108 can be performed at varying levels of granularity (e.g., single-pixel changes in distance or batch changes in distance) to provide for more or less fluid animations.

FIG. 2 is a flow diagram illustrating a method for adjusting a UI tile according to some embodiments.

In step 202, the method can comprise calculating an interaction position.

In one embodiment, when a user interacts with a scroll view or tile situated therein, a move distance is calculated. In an embodiment, the move distance comprises an amount (in, for example, pixels) to move the tiles in the scroll view along a horizontal axis. The specifics of calculating a move distance may vary based on the underlying operating system of the mobile device. In general, however, the method can comprise determining a start position of the interaction (e.g., swipe) and an end position of the interaction. In some embodiments, the end position can comprise a position when a user ceases the interaction or can comprise an intermediate point of the interaction. For example, the method can compute the distance at the end of the interaction or at each point along a path of the interaction.

In one embodiment, the interaction is managed by the scroll view and not individual tiles. In such an embodiment, the user may perform the interaction at any location within the scroll view. In some embodiments, the method can further determine the direction of the interaction.

In step 204, the method can comprise selecting a secondary tile that is adjacent to the main tile.

As described previously, a main tile can comprise a tile situated in a prominent position of the scroll view (e.g., the first indexed location of the scroll view). The selected adjacent secondary tile can comprise a tile to the left or right of the main tile, based on the direction of the interaction. For example, if the interaction comprises a swipe to the right, the secondary tile situated to the “left” of the main tile (from the perspective of a user) is selected. Similarly, if the interaction comprises a swipe to the left, the secondary tile situated to the “right” of the main tile (from the perspective of a user) is selected. In some embodiments, if no such tile exists, the scroll view does not move, and the method ends since the interaction is attempting to move the scroll view beyond what content is available. For example, if the main tile is situated on the screen and no secondary tile is to the left of the main tile, a swipe to the right would result in no movement or further operations.

In some embodiments, the method can select multiple secondary tiles and adjust the properties of these multiple secondary tiles based on their distance from the main tile as well as the interaction position and distance, as will be described.

In step 206, the method can comprise adjusting the display properties of one or more secondary tiles based on the interaction position. Details of these steps are provided in FIG. 3, which is incorporated herein.

In brief, the method can compute a change in position caused by the interaction and determine how close or far a given secondary tile is from the position of the main tile. In some embodiments, this change can be represented as a percentage, the percentage representing how far along the path to the main tile the secondary tile has moved. When a main tile is fully displayed, the secondary tile's percentage is zero. When the secondary tile fully replaces the main tile, the secondary tile's percentage is 100. During a move, this percentage gradually changes as the tile moves toward or away from the main tile slot.

In some embodiments, if the secondary tile is not immediately adjacent to the main tile, the percentage can be scaled accordingly. For example, if the secondary tile is separate from the main tile by one other secondary tile, the percentage to the main tile slot can be divided by two. In another embodiment, the percentage can be computed as the percentage to the next slot. For example, if the secondary tile is not immediately adjacent to the main tile, the percentage of the non-immediate secondary tile to the currently immediate secondary tile can be computed and used as the percentage. In some embodiments, only the secondary tiles adjacent to the main tile, and the main tile itself, are modified.

Based on this percentage value, the method can compute a change in one or more display properties of the secondary tile. Examples of display properties include the text size of an element, the transparency of an element, the position of an element, and the presence of an element. In some embodiments, combinations of such display properties can be adjusted simultaneously. For example, FIG. 6A illustrates a secondary tile with a percentage of zero, FIG. 6B illustrates a secondary tile with a percentage of 50%, and FIG. 6C illustrates a secondary tile with a percentage of 100%. Each figure illustrates the changes in display properties, and reference is made to the descriptions of those figures.

In step 208, the method can comprise repositioning the main and selected secondary tiles. In one embodiment, the method can utilize the move distance utilize to calculate the percentage change to move the tiles by the interaction distance. In one embodiment, steps 206 and 208 can be swapped or performed simultaneously.

In step 210, the method can comprise determining if the interaction is ongoing. If so, the method continues to execute steps 202 through 208 for each movement. For example, if a swipe comprises a move of ten pixels, steps 202 and 208 can be executed ten times for each pixel moved. If, in step 210, the method determines that the interaction has finished, the method ends.

FIG. 3 is a flow diagram illustrating a method for adjusting the display properties of a UI tile according to some embodiments. As described in connection with FIG. 2, the method of FIG. 3 can be executed for any movement of any tile. For example, when a tile moves a pixel in the horizontal direction, the method of FIG. 3 can be executed as part of that movement.

In step 302, the method can comprise determining an interaction percentage to target.

As described above, each tile in a scroll view can be associated with an origin point (e.g., the top left corner of the tile). In some embodiments, this origin can be relative to the scroll view, another container, or the screen itself. As one example used throughout, the origins of three horizontally-positioned tiles can be (0, 0), (100, 0), and (200, 0).

In step 302, the method receives a distance of an interaction position. For example, a user may swipe or mouse scroll the scroll view by a fixed amount. As one example, a swipe gesture can be computed as comprising a 50-pixel distance. In one embodiment, the method computes the differences between tiles. In the example, the distance between each tile is 100 pixels. In this embodiment, the method can then divide the distance between tiles by the interaction distance to obtain an interaction percentage (e.g., 50% in the example). In some embodiments, the distance between tiles can be known in advance and static and thus comprise a table lookup.

In step 304, the method can comprise adjusting a text size of an element based on the percentage.

In one embodiment, various elements of a tile can be associated with transition parameters, including text size transition parameters. In one embodiment, these parameters can include a minimum and maximum text size (e.g., 6 pt and 24 pt, respectively). In some embodiments, the transition is presumed to be linear. That is, for an 18 pt difference in the previous example, a 10% position change will result in a 1.8 change in point size. In other embodiments, different types of transitions can be specified in the parameters such as a logarithmic, exponential, or sigmoid transition. In an embodiment, the method uses the interaction percentage to compute a text size change. For a linear transition, this can be represented as:

size_{new}=change·(max−min),

where change comprises the interaction percentage, max comprises the maximum text size, and min comprises the minimum text size. In some embodiments, the minimum value corresponds to the text size when a tile is fully in a secondary slot, whereas the maximum value corresponds to the text size when a tile is fully in a main tile slot.

In step 306, the method can comprise adjusting positions of elements based on the interaction percentage.

Similar to the description of step 304, the transition parameters for a given element in a tile can include element path parameters which describe how an element travels within a tile. The format of the element path parameters can take various forms. In one embodiment, the element path parameters can include a start coordinate and an end coordinate relative to the tile. The element path parameters can also include a type of path (e.g., linear, arc, etc.) with any necessary parameters to define the path. For a linear path, only a start and end coordinate may be needed. For an arced path, the element path parameters can further include a focal point to define the size of the arc. In other examples, a polynomial equation can be used as the path, and the element path parameters can include the coefficients of the equation. In yet another embodiment, the element path parameters can include an unbounded and ordered series of coordinates between the start and end coordinates. In such an embodiment, the method can move the element in linear segments between each set of coordinates to allow for any arbitrary path. Similar to the change in text size, in some embodiments, the method can define a path function based on the element path parameters and input the interaction percentage as an input to generate the new position of the element.

In step 308, the method can comprise adjusting an element transparency and presence level based on the interaction percentage.

In some embodiments, the transparency level of an element can be determined similar to that of text size. Specifically, a maximum and minimum transparency can be set, and the percentage can be multiplied by the difference of the maximum and minimum to obtain a transparency level.

In some embodiments, the method can determine when to visibly display an element based on a presence level. In some embodiments, a presence level is optional. In some embodiments, transparency can be used to mimic presence. If implemented, a presence level can be defined as when to begin displaying an element. In some embodiments, the element path parameters can include a fixed percentage (e.g., 50%) where an element should start being displayed. In some embodiments, the presence level can be combined with other adjustments. If, in such an embodiment, the presence level is set to hide the element, the other adjustments will not be visible (but may still be applied).

FIG. 4 is a flow diagram illustrating a method for updating a UI display according to some embodiments of the disclosure.

In step 402, the method can comprise determining if the movement of a secondary tile is complete. As used herein, a complete movement refers to a secondary tile replacing a main tile as a result of the interaction. By contrast, an incomplete movement refers to an interaction that does not fully replace a main tile.

If the method determines that the interaction was complete, in step 404, the method sets the current secondary tile situated in the main tile slot as the main tile. Similarly, the method sets the previous main tile as a secondary tile. If, by contrast, the method detects that the secondary tile has not fully replaced the main tile, the method may revert the changes made to the appearance of all tiles in step 406 and move the tiles back to an original position. In such a scenario, the tiles may appear to “bounce back” to their original positions. In some embodiments, the method can re-execute the method of FIG. 3 during this reversion to revert the change made in step 112. Thus, as an example, text sizes may return to the original state prior to execute step 112 during a first move. In step 408, the method can comprise updating the display of the mobile device via the scroll view with the new tiles, each tile having adjusted parameters.

In some embodiments, steps 402, 404, and 406 can be optional. In this scenario, the method can support the partial movement of secondary tiles wherein the properties are adjusted to a midpoint position during the movement and displayed to the user.

FIG. 5 is a user interface diagram of a portrait-oriented UI according to some embodiments.

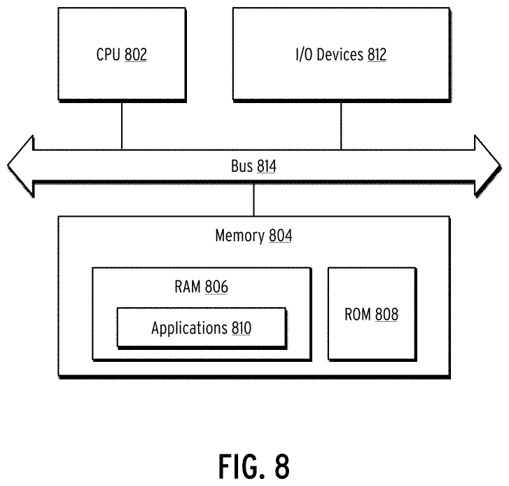

In the illustrated embodiment, a screen 500 of a computing device, such as that described in FIG. 8, is depicted. In an embodiment, the screen 500 can comprise a screen of a mobile device such as a mobile phone or tablet. In other embodiments, the screen 500 can comprise the screen of a laptop or desktop device. In some embodiments, the screen 500 comprises the entire viewable area of a display device. In other embodiments, the screen 500 depicts a portion of a screen. For example, screen 500 can comprise a rectangular area of a webpage. The specific dimensions of screen 500 are not provided and are not limiting.

The screen 500 includes a first portion 534. In one embodiment, the first portion 534 can comprise a scroll view or carousel, as previously discussed. In the illustrated embodiment, the first portion 534 includes a main tile 502 and a secondary tile 516 adjacent to the main tile 502. As described in previous figures, main tile 502 and secondary tile 516 are movable along a horizontal axis. As such, when a user performs an interaction (e.g., a swipe gesture) on the first portion 534, main tile 502 and secondary tile 516 will move accordingly. When, for example, secondary tile 516 is situated at the position of main tile 502, the secondary tile 516 effectively replaces the main tile 502 and is then set as the new main tile as described in FIG. 4.

As illustrated, a given tile can include various elements. For example, the main tile 502 includes a label element 532, a title text element 504, a time text element 506, a subtitle text element 508, a date text element 510, a control element 512, and a graphic element 514. The title text element 504, time text element 506, subtitle text element 508, and date text element 510 can comprise label elements or similar mobile UI elements that include text data. As such, they have various properties such as position, height, width, text size, font color, transparency, visibility, etc. The graphic element 514 and control element 512 may include overlapping properties such as transparency, position, height, width, visibility as well as other properties. For example, the control element 512 can include a target or action trigger when interacted with. Similarly, the graphic element 514 can include a resolution property or other graphic-specific property.

The screen 500 additionally includes a plurality of tabs, including cycling tab 518A, rowing tab 518B, running tab 518C, and FitPass tab 518D. In the illustrated embodiment, one of the tabs (e.g., FitPass tab 518D) may be selected, and the corresponding items in the first portion 534 may be categorized as such. Upon selection of a different tab, different tiles may be loaded in first portion 534. In an embodiment, the current tiles may be faded out, and new tiles may be faded in, replacing the old tiles.

The screen 500 additionally includes a challenges portion 536. In an embodiment, the challenges portion 536 can include its own tiles, such as main tile 520 and secondary tiles. Details of challenges portion 536 are similar to that of first portion 534, and the disclosure of the operation of first portion 534 is not repeated for challenges portion 536. The screen 500 additionally includes a classes portion 538. In an embodiment, the classes portion 538 can also include a mail tile 522 that includes text elements such as title element 524, instructor element 526, and subtitle element 528. Each of these text elements may be adjusted as described previously and as will be described with respect to first portion 534.

Finally, the screen 500 includes a tab bar 540. In the illustrated embodiment, the tab bar 540 can include a plurality of icons for changing the contents of screen 500.

In an embodiment, the screen 500 can comprise an initial state of the application upon launch. That is, screen 500 can comprise the application prior to user interaction. As described in the preceding figures, users can interact with the various sections by, for example, swiping left or right to view secondary tiles (e.g., secondary tile 516).

FIGS. 6A through 6C are user interface diagrams of a UI tile in various states according to some embodiments.

In FIG. 6A, a secondary tile 600A is first depicted in a fully secondary state. As used herein, a fully secondary state refers to a position of a tile that is furthest away from the next slot in a carousel. For example, secondary tile 516 in FIG. 5 comprises a secondary tile in a fully secondary state. In FIG. 6B, Secondary tile 600B illustrates the secondary tile 600A after an interaction causes the tile to move toward a main tile slot (e.g., the position of main tile 502 in FIG. 5). As illustrated in FIG. 6B, secondary tile 600B comprises a secondary tile that has been moved halfway (e.g., 50%) toward a main tile slot. Finally, as illustrated in FIG. 6C, the secondary tile 600C comprises a secondary tile that has been fully moved into main tile slot and thus replaces the previous main tile, becoming the main tile itself.

In secondary tile 600A, multiple UI elements are illustrated, including a banner 602, title 604, time 606, instructor 608, date 610, and graphic 612. In an embodiment, title 604, time 606, instructor 608, and date 610 can comprise text elements such as labels. In an embodiment, banner 602 can comprise a custom UI element. As illustrated in the following figures, some elements such as banner 602 may not be modified during movement. In an embodiment, graphic 612 can comprise a bitmap or vector graphic image. In an embodiment, the title 604, time 606, instructor 608, and date 610 are depicted as having an initial state. In an embodiment, the initial state comprises a minimum value for all properties of the elements. For example, the title 604, time 606, instructor 608, and date 610 can be set as their minimum allowable text size. Further, as will be illustrated, the title 604, time 606, instructor 608, and date 610 can be set to an initial position relative to the secondary tile 600A. In the illustrated embodiment, the graphic 612 is depicted as being partially transparent (e.g., 80%).

In secondary tile 600B, the tile has been moved 50% closer to the main tile slot. As discussed in the previous methods, the properties of the title 604, time 606, instructor 608, date 610, and graphic 612 are adjusted accordingly. Specifically, title 614, time 616, instructor 618, and date 620 are increased in text size. In one embodiment, title 614 is maximized to a size 50% of the maximum size depicted in FIG. 6C. However, in the illustrated embodiment, time 616, instructor 618, and date 620 are maximized to a size close to the maximum size. In such an embodiment, the time 616, instructor 618, and date 620 may be associated with a logarithmic function to increase the size. Additionally, the positions of title 614, time 616, instructor 618, and date 620 are changed to move the title 614, time 616, instructor 618, and date 620 closer to the vertical center of the secondary tile 600B via a linear function. Additionally, title 614 is moved to be separate from time 616, instructor 618, and date 620. Further, the transparency graphic 624 is increased to 40% from 80%.

In addition to changing the properties of existing elements, a new button 622 was displayed in the secondary tile 600B. As illustrated, in an embodiment, the properties of the button 622 are also modified. For example, border and fill colors are removed, leaving only the text. In some embodiments, the transparency, size, and position can also be set in FIG. 6B.

In FIG. 6C, the secondary tile 600C has reached the main tile slot, and the final adjustments are illustrated. In an embodiment, certain fields such as time 628, instructor 630, and date 632 are only minimally changed due to the use of logarithmic functions. By contrast, the title 626 is further increased in text size and position to its maximum size. Further, graphic 636 is increased to its maximum transparency value (0%). Further, the button 634 is moved to its final position, and its border and fill is added. In some embodiments, the button 634 may also be enabled in secondary tile 600C, whereas in secondary tile 600B, the button 622 may not be selectable.

While only a single intermediate tile (secondary tile 600B) is illustrated, more tiles can be inserted based on the granularity of the distances measured. Thus, a tile for a 1%, 2%, 3%, etc., move can be continuously calculated and displayed as the secondary tiles move toward a main tile slot. Further, the ordering of the transition may be reversed as a main tile moves away from a main tile slot. Thus, after secondary tile 600C is displayed, secondary tile 600B may be displayed as the tile moves away, and secondary tile 600A may be displayed once the main tile is completely removed from the main tile slot.

FIG. 7 is a user interface diagram of a landscape-oriented UI according to some embodiments. Various elements of FIG. 7 bearing the same reference numerals of that in FIG. 5 are not described again here and those descriptions are incorporated herein in their entirety.

In the illustrated embodiment, a screen 700 is illustrated in landscape mode. In an embodiment, the screen 700 can comprise the screen 500 of FIG. 5 after a user rotates a mobile device ninety degrees.

In the illustrated embodiment, the dimensions and features of main tile 702 may be substantially unchanged from that of main tile 502. By contrast, the screen 700 increases the horizontal screen real estate of the first portion 534 and thus allows for more content to be displayed in the secondary slots such as first secondary slot 704 and second secondary slot 706. As illustrated, first secondary slot 704 and second secondary slot 706 can both include a title and other text fields at their minimum property values. As the first secondary slot 704 is moved toward the position of the main tile 702, the first secondary slot 704 will change appearance as described previously. In some embodiments, the second secondary slot 706 will simultaneously move with the first secondary slot 704 toward the position of the first secondary slot 704. However, since the second secondary slot 706 is not moving to replace a main tile, the second secondary slot 706 may not change in appearance. Thus, in some embodiments, the only tiles involved in changing an appearance in the illustrated embodiment (and all embodiments) may only be the main tile and the two tiles adjacent to the main tile.

FIG. 8 is a block diagram of a computing device according to some embodiments of the disclosure.

As illustrated, the device includes a processor or central processing unit (CPU) such as CPU 802 in communication with a memory 804 via a bus 814. The device also includes one or more input/output (I/O) or peripheral devices 812. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 802 may comprise a general-purpose CPU. The CPU 802 may comprise a single-core or multiple-core CPU. The CPU 802 may comprise a system-on-a-chip (SoC) or a similar embedded system. In some embodiments, a GPU may be used in place of, or in combination with, a CPU 802. Memory 804 may comprise a memory system including a dynamic random-access memory (DRAM), static random-access memory (SRAM), Flash (e.g., NAND Flash), or combinations thereof. In one embodiment, bus 814 may comprise a Peripheral Component Interconnect Express (PCIe) bus. In some embodiments, bus 814 may comprise multiple busses instead of a single bus.

Memory 804 illustrates an example of computer storage media for the storage of information such as computer-readable instructions, data structures, program modules, or other data. Memory 804 can store a basic input/output system (BIOS) in read-only memory (ROM), such as ROM 808, for controlling the low-level operation of the device. The memory can also store an operating system in random-access memory (RAM) for controlling the operation of the device

Applications 810 may include computer-executable instructions which, when executed by the device, perform any of the methods (or portions of the methods) described previously in the description of the preceding Figures. In some embodiments, the software or programs implementing the method embodiments can be read from a hard disk drive (not illustrated) and temporarily stored in RAM 806 by CPU 802. CPU 802 may then read the software or data from RAM 806, process them, and store them in RAM 806 again.

The device may optionally communicate with a base station (not shown) or directly with another computing device. One or more network interfaces in peripheral devices 812 are sometimes referred to as a transceiver, transceiving device, or network interface card (NIC).

An audio interface in peripheral devices 812 produces and receives audio signals such as the sound of a human voice. For example, an audio interface may be coupled to a speaker and microphone (not shown) to enable telecommunication with others or generate an audio acknowledgment for some action. Displays in peripheral devices 812 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 812 may comprise any input device arranged to receive input from a user. An illuminator in peripheral devices 812 may provide a status indication or provide light. The device can also comprise an input/output interface in peripheral devices 812 for communicating with external devices, using communication technologies, such as USB, infrared, Bluetooth™, or the like. A haptic interface in peripheral devices 812 provides tactile feedback to a user of the client device.

A GPS receiver in peripheral devices 812 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, provide other information that may be employed to determine the physical location of the device, including, for example, a media access control (MAC) address, Internet Protocol (IP) address, or the like.

The device may include more or fewer components than those shown in FIG. 8, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein. Example embodiments are provided merely to be illustrative. Likewise, the reasonably broad scope for claimed or covered subject matter is intended. Among other things, for example, the subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms such as “and,” “or,” or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, can be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order. For example, two blocks shown in succession can, in fact, be executed substantially concurrently, or the blocks can sometimes be executed in the reverse order, depending upon the functionality/acts involved.

For the purposes of this disclosure, a non-transitory computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media for tangible or fixed storage of data or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, cloud storage, magnetic cassettes, magnetic tape, magnetic disk storage, or other magnetic storage devices, or any other physical or material medium which can be used to tangibly store the desired information or data or instructions and which can be accessed by a computer or processor.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

1. A method comprising:
displaying a main tile in a user interface (UI);
detecting a user interaction with the UI;
moving the main tile and a secondary tile, the secondary tile adjacent to the main tile; and
adjusting a property of the secondary tile while moving the secondary tile, the property adjusted based in part on a position of the secondary tile during the moving.

2. The method of claim 1, further comprising displaying the secondary tile prior to moving the main tile and the secondary tile, wherein the displaying the secondary tile comprises displaying a portion of the secondary tile.

3. The method of claim 1, wherein moving the main tile and the secondary tile comprises scrolling the main tile and the secondary tile along a horizontal axis of the UI.

4. The method of claim 1, wherein detecting the user interaction comprises detecting a swipe gesture.

5. The method of claim 1, wherein adjusting the property of the secondary tile comprises increasing a text size of an item of the secondary tile proportionate to a change in position caused by the moving.

6. The method of claim 1, wherein adjusting the property of the secondary tile comprises adjusting a position of an item of the secondary tile proportionate to a change in position caused by the moving.

7. The method of claim 1, wherein adjusting the property of the secondary tile comprises adjusting a transparency of an item of the secondary tile proportionate to a change in position caused by the moving.

8. The method of claim 1, wherein adjusting the property of the secondary tile comprises displaying a control.

9. The method of claim 1, wherein adjusting the property of the secondary tile comprises:
increasing a text size of an item of the secondary tile proportionate to a change in position caused by the moving;
adjusting a position of the item of the secondary tile proportionate to the change in position caused by the moving;
adjusting a transparency of the item of the secondary tile proportionate to the change in position caused by the moving; and
displaying a control.

10. A non-transitory computer-readable storage medium for tangibly storing computer program instructions capable of being executed by a computer processor, the computer program instructions defining steps of:
displaying a main tile in a user interface (UI);
detecting a user interaction with the UI;
moving the main tile and a secondary tile, the secondary tile adjacent to the main tile; and
adjusting a property of the secondary tile while moving the secondary tile, the property adjusted based in part on a position of the secondary tile during the moving.

11. The non-transitory computer-readable storage medium of claim 10, the steps further comprising displaying the secondary tile prior to moving the main tile and the secondary tile, wherein the displaying the secondary tile comprises displaying a portion of the secondary tile.

12. The non-transitory computer-readable storage medium of claim 10, wherein moving the main tile and the secondary tile comprises scrolling the main tile and the secondary tile along a horizontal axis of the UI.

13. The non-transitory computer-readable storage medium of claim 10, wherein detecting the user interaction comprises detecting a swipe gesture.

14. The non-transitory computer-readable storage medium of claim 10, wherein adjusting the property of the secondary tile comprises increasing a text size of an item of the secondary tile proportionate to a change in position caused by the moving.

15. The non-transitory computer-readable storage medium of claim 10, wherein adjusting the property of the secondary tile comprises adjusting a position of an item of the secondary tile proportionate to a change in position caused by the moving.

16. The non-transitory computer-readable storage medium of claim 10, wherein adjusting the property of the secondary tile comprises adjusting a transparency of an item of the secondary tile proportionate to a change in position caused by the moving.

17. The non-transitory computer-readable storage medium of claim 10, wherein adjusting the property of the secondary tile comprises displaying a control.

18. The non-transitory computer-readable storage medium of claim 10, wherein adjusting the property of the secondary tile comprises:
increasing a text size of an item of the secondary tile proportionate to a change in position caused by the moving;
adjusting a position of the item of the secondary tile proportionate to the change in position caused by the moving;
adjusting a transparency of the item of the secondary tile proportionate to the change in position caused by the moving; and
displaying a control.

19. A device comprising:
a processor configured to:
display a main tile in a user interface (UI);
detect a user interaction with the UI;
move the main tile and a secondary tile, the secondary tile adjacent to the main tile; and
adjust a property of the secondary tile while moving the secondary tile, the property adjusted based in part on a position of the secondary tile during the moving.

20. The device of claim 19, wherein adjusting the property of the secondary tile comprises one of:
increasing a text size of an item of the secondary tile proportionate to a change in position caused by the moving;
adjusting a position of the item of the secondary tile proportionate to the change in position caused by the moving;
adjusting a transparency of the item of the secondary tile proportionate to the change in position caused by the moving; or
displaying a control.
